(19) United States
(12) Patent Application Publication
(10) Pub. No.: US 2024/0290101 A1
(43) Pub. Date: Aug. 29, 2024

(54) INFORMATION PROCESSING DEVICE, INFORMATION PROCESSING METHOD, AND PROGRAM

(71) Applicant: Panasonic Intellectual Property Management Co., Ltd., Osaka (JP)

(72) Inventor: Kazuhiro YANAGI, Fukuoka (JP)

(73) Assignee: Panasonic Intellectual Property Management Co., Ltd., Osaka (JP)

(21) Appl. No.: 18/573,331

(22) PCT Filed: May 17, 2022
(86) PCT No.: PCT/JP2022/020571

§ 371 Date: Dec. 21, 2023

(30) Foreign Application Priority Data
Jun. 29, 2021 (JP) 2021-107594

(51) Int. Cl. G06V 20/52; G07C 9/37

(52) U.S. Cl. CPC G06V 20/52; G07C 9/37

(57) ABSTRACT

This information processing device comprises: a detection unit that detects a foreign object which is not included in an image of a normal state, such detection performed in each of a plurality of zones set for a passageway in the image in which the passageway is captured from above; and a determination unit that determines whether a person corresponding to the foreign object has passed through the passageway on the basis of a change over time in the zone where the foreign object was detected.

### TECHNICAL FIELD

The present disclosure relates to an information processing apparatus, an information processing method, and a program.

### BACKGROUND ART

There is a technology of managing entry and exit of a person passing through a gate installed at a train station, an airport, or the like. For example, Patent Literature (hereinafter referred to as “PTL”) 1 describes an apparatus that, in a case where a person is authorized to pass through a gate by using a radio card and enters the gate from the entrance of the gate, tracks whether the person has passed through the gate (whether the person has returned to the entrance of the gate) based on a change in the position of the radio card.

### CITATION LIST

### Patent Literature

PTL 1
Japanese Patent Application Laid-Open No. H09-330440

### SUMMARY OF INVENTION

In a gate system (for example, a face authentication gate system) in which a person is authorized to pass through a gate without using a radio card carried by the person, there is room for consideration as to how to surely determine whether the person has passed through a passageway in the gate.

One non-limiting and exemplary embodiment of the present disclosure facilitates providing an information processing apparatus, an information processing method, and a program each capable of improving the determination accuracy of determining whether a person has passed through a specific passageway such as a passageway in a gate.

An information processing apparatus according to one exemplary embodiment of the present disclosure includes: a detector that performs detection of a foreign object, in an image obtained by capturing a passageway from above, for each of a plurality of zones set to the passageway, where the foreign object is an object not included in the image in a stationary state; and a determiner that determines whether a person corresponding to the foreign object has passed through the passageway based on a change over time in a zone in which the foreign object is detected, among the plurality of zones.

It should be noted that a general or specific embodiment may be implemented as a system, an apparatus, a method, an integrated circuit, a computer program, a storage medium, or any selective combination thereof.

One exemplary embodiment of the present disclosure makes it possible to improve the determination accuracy of determining whether a person has passed through a specific passageway such as a passageway in a gate.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating a configuration example of passage management system 1 of a face authentication ticket gate according to an embodiment;

FIG. 2 is a perspective view illustrating a configuration example of the face authentication ticket gate:

FIG. 3 is a block diagram illustrating a configuration example of a terminal PC exemplified in FIG. 1:

FIG. 4 illustrates an example of a passageway image captured by a surveillance camera exemplified in FIG. 1:

FIG. 5 illustrates an example in which a plurality of areas is set for the passageway image exemplified in FIG. 4;

FIG. 6 illustrates an example in which an area in which a person is detected changes in sequence according to a time lapse:

FIG. 7 illustrates an example of the relationship between the time lapse and the areas in which the person is detected as exemplified in FIG. 6;

FIG. 8 illustrates an example in which the order of areas in which a person is detected is reversed in the middle according to a time lapse:

FIG. 9 illustrates an example of the relationship between the time lapse and the areas in which the person is detected as exemplified in FIG. 8:

FIG. 10 illustrates an example in which an area in which a person is detected does not change in the middle according to a time lapse:

FIG. 11 illustrates an example of the relationship between the time lapse and the areas in which the person is detected as exemplified in FIG. 10;

FIG. 12 illustrates an example in which areas in which two persons are detected, respectively, change in sequence according to a time lapse:

FIG. 13 illustrates an example of the relationship between the time lapse and the areas in which the persons are detected as exemplified in FIG. 12;

FIG. 14 illustrates an example in which areas in which two persons among three persons are detected, respectively, change in sequence and the order of areas in which the remaining one person is detected is reversed in the middle, according to a time lapse:

FIG. 15 illustrates an example of the relationship between the time lapse and the areas in which the persons are detected as exemplified in FIG. 14;

FIG. 16 is a flowchart illustrating an operation example regarding pre-setting of the terminal PC exemplified in FIGS. 1 and 3:

FIG. 17 is a flowchart illustrating an operation example of the terminal PC, exemplified in FIGS. 1 and 3, during operation:

FIG. 18 is a flowchart illustrating an operation example regarding passage determination by the terminal PC exemplified in FIGS. 1 and 3:

FIG. 19 is a diagram provided for describing Variation 1 of an embodiment:

FIG. 20 is a diagram provided for describing Variation 1 of an embodiment:

FIG. 21 is a diagram provided for describing Variation 1 of an embodiment:

FIG. 22 is a diagram provided for describing Variation 2 of an embodiment:

FIG. 23 is a diagram provided for describing Variation 2 of an embodiment:

FIG. 24 is a diagram provided for describing Variation 4 of an embodiment:

FIG. 25 is a diagram provided for describing Variation 5 of an embodiment;

FIG. 26 is a diagram provided for describing Variation 6 of an embodiment:

FIG. 27 is a diagram provided for describing Variation 7 of an embodiment;

FIG. 28 is a diagram provided for describing Variation 7 of an embodiment:

FIG. 29 is a diagram provided for describing Variation 8 of an embodiment:

FIG. 30 is a diagram provided for describing Variation 9 of an embodiment;

FIG. 31 is a diagram provided for describing Variation 9 of an embodiment; and

FIG. 32 illustrates a hardware configuration example of a computer.

### DESCRIPTION OF EMBODIMENTS

Hereinafter, a preferred embodiment of the present disclosure will be described in detail with reference to the accompanying drawings. Note that, in the present specification and drawings, components having substantially the same function are provided with the same reference sign to omit redundant description.

### One Embodiment

Ticket gates of the transportation system (for example, the train) using face authentication having been considered as next generation ticket gates. For example, a person is captured by a face authentication camera attached to a ticket gate. The captured image information is transmitted to an authentication apparatus (for example, a server) in which face image information for face authentication is registered. The server performs authentication based on the received image information and the registered face image information, and returns an authentication result (for example, authentication success (OK) or authentication failure (NG)) to the ticket gate. The ticket gate controls, for example, the opening and closing of the gate in response to the authentication result.

In a ticket gate using such face authentication (hereinafter which may also be referred to as a face authentication ticket gate), for example, unlike a system using a touch-type integrated circuit (IC) card or a magnetic ticket to be inserted into a ticket gate, it may be difficult to determine the “intention” of a person to be authenticated who passes through the ticket gate. For example, face authentication using image information captured by a camera may be established just by a person looking into a ticket gate, and it may be determined that the person has entered the ticket gate and the person may be charged.

Such a situation is avoidable by providing a ticket gate with, for example, an operator that triggers the start of face authentication, such as a “face authentication start button”, in which case, however, a person who attempts to pass through the ticket gate once stops and operates the operator, which may impair the significance or convenience of using face authentication at the ticket gate through which numerous persons are assumed to pass during a short period of time.

For this reason, it is crucial to determine “whether a person who has succeeded in authentication has surely passed through a ticket gate”. For example, a technique has been considered in which a camera is installed above a ticket gate and tracking is performed by specifying a person based on an image of the person captured from above (for example, overhead) by the camera.

Nevertheless, since persons have differences in hair color or in terms of whether the persons have things to wear (for example, a hat or cap, a helmet, or the like), it is difficult to specify a person based on image information of the person captured from overhead, and the accuracy of determination or tracking may decrease.

Further, it may also be difficult, depending on the environment around a ticket gate (for example, the color of the floor surface at the ticket gate, or external light), to separate a person from the environment and perform determination. Further, in addition to temporal changes, it is also possible to consider a case where determination may be difficult due to an influence of lighting installed around a ticket gate or of a shadow.

Further, since the ceiling height around a ticket gate may vary (in other words, the capture environment by a camera may vary) depending on the train station, setting or learning adapted to such a capture environment (for example, a library learned according to the capture environment is prepared for each train station) may be required. It is time-consuming and unrealistic to perform setting or learning for each of different capture environments.

In one exemplary embodiment of the present disclosure, for example, a camera for monitoring a passageway in a ticket gate from above the ticket gate (hereinafter which may also be referred to as a surveillance camera) is installed and a passageway image captured by the surveillance camera is divided (or partitioned) into a plurality of areas (or zones). Then, for each of the divided areas (hereinafter each of which may also be abbreviated to “division area”), it is detected, for example, whether a person has entered each of the areas, and it is determined based on a time-series change (in other words, a change over time) in the detection result whether the person has passed through the ticket gate.

For example, difference detection, or foreign object detection using deep learning by regarding a person as a foreign object may be used for entrance detection of the person for each division area. For example, it may be detected which division area a person has entered by comparing a passageway image captured by a surveillance camera in a state in which no person is present in a ticket gate (which will be referred to as “stationary state” for convenience) with a passageway image captured by the surveillance camera in a non-stationary state (for example, during operation of a face authentication ticket gate). For example, in a case where a portion in a passageway image of a non-stationary state, where the portion differs from that in a passageway image in a stationary state, is detected, it can be determined that a person has entered the division area corresponding to the portion.

Accordingly, for example, in a case where the division area in which the entrance of a person is detected (hereinafter which may also be referred to as “person detection area” or “entrance detection area”) changes in sequence over time, it can be determined that the person is moving in the ticket gate. Further, for example, it can be determined that the person has passed through the ticket gate with detection of the entrance of the person in the division area corresponding to the exit of the ticket gate.

For example, in a case where the foreign object detection area does not change in sequence over time, on the other hand, it can be determined that the person has not passed through the ticket gate.

A ticket gate usually has a passageway width through which persons can pass one by one (in other words, does not have a passageway width through which a plurality of persons can pass side by side). For this reason, it is hard to assume that a situation in which a person who has entered a ticket gate overtakes another person who had entered the ticket gate ahead or is overtaken by another person who has entered the ticket gate thereafter (in other words, replacement of a person at the front with a person at the rear) occurs.

Accordingly, even in a case where a plurality of persons is present in a ticket gate, the state of passage through the ticket gate is distinguishable for each of the plurality of person by following time-series changes in entrance detection for each division area.

Further, it is not necessary to constantly perform entrance detection for each division area. For example, entrance detection for each division area may be performed according to the timing at which face authentication is performed. Further, a passageway image in a stationary state may be acquired in an arbitrary time slot (or timing) such as, at the time of installation of passage management system 1 including ticket gate 40 and surveillance camera 12, at the time of maintenance thereof, in the morning, during the daytime, or at night, for example.

For detecting a person surely, an image with neither persons nor foreign objects may be used as a passageway image in a stationary state. At the time of the installation and at the time of the maintenance, it is highly likely that no persons and foreign objects as such will be present on the passageway, and thus, it is highly likely that a good image in a stationary state will be obtained. Note that, it may also be configured such that a passageway image in a stationary state can be captured by an instruction from the user. In this case, the user may visually confirm whether there are persons, foreign objects, and/or the like on the passageway. Further, in a case where ticket gate 40 is installed outdoors, a shadow or the like falling on the passageway, which varies depending on the time slot, may be detected erroneously as a person. For suppressing occurrence of this problem, passageway images in a stationary state in a plurality of time slots may be acquired and a passageway image in the same time slot as a current time slot may be use in passage management.

For example, a passageway image in a stationary state may be acquired, based on the state of face authentication using face authentication camera 11 installed at ticket gate 40, at a timing at which it is detected that no person is present on the passageway of ticket gate 40. Further, in a case where a photoelectric sensor is installed at ticket gate 40, a passageway image in a stationary state may be acquired by using the photoelectric sensor to specify a timing at which it is detected that no person is present on the passageway of ticket gate 40.

### [System Configuration Example]

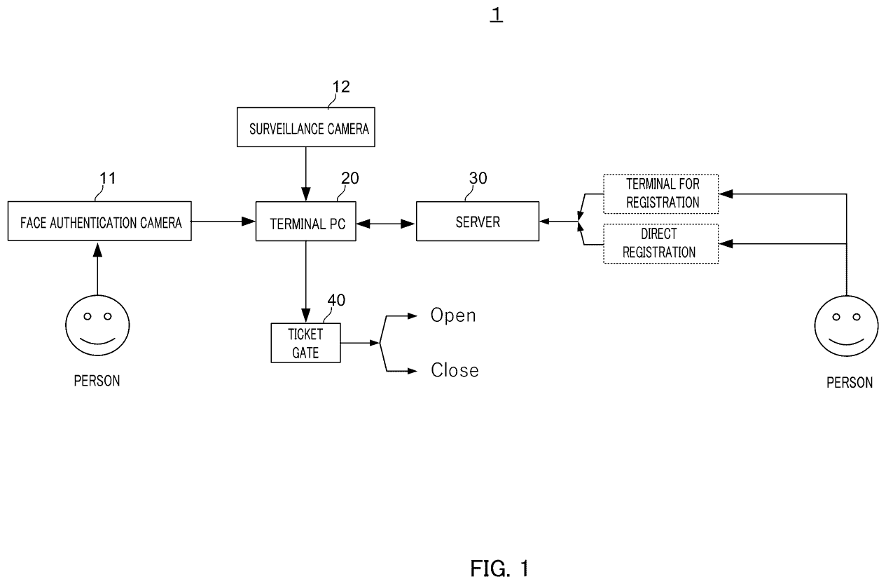

FIG. 1 is a block diagram illustrating a configuration example of passage management system 1 of a face authentication ticket gate according to an embodiment.

As exemplified in FIG. 1, passage management system 1 includes, for example, face authentication camera 11, surveillance camera 12, terminal PC (personal computer) 20, server 30, and ticket gate (gate) 40.

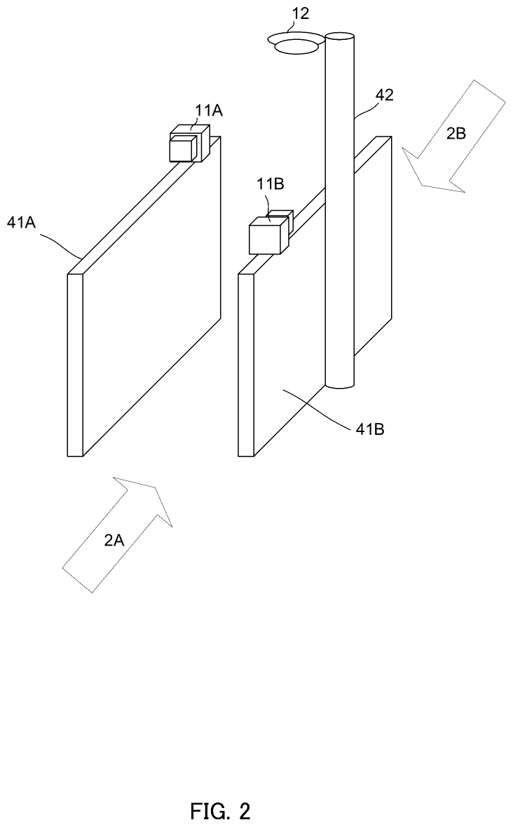

Face authentication camera 11, for example, captures a region including the face of a person who passes through ticket gate 40, and outputs the captured image to terminal PC 20. For example, as illustrated in FIG. 2, face authentication camera 11 may be provided at one or both of side walls 41A and 41B of ticket gate 40, which face each other. Note that, the space held between side walls 41A and 41B forms the passageway in ticket gate 40.

For example, as illustrated in FIG. 2, camera 11A that captures a person entering ticket gate 40 in the direction indicated with arrow 2A in FIG. 2 may be installed in an upper portion of side wall 41A as one side wall. Further, camera 11B that captures a person entering ticket gate 40 in the opposite direction (for example, the direction indicated with arrow 2B in FIG. 2) may be installed in an upper portion of side wall 41B as the other side wall.

In other words, by face authentication, a person who utilizes ticket gate 40 can pass through ticket gate 40 both in the direction indicated with arrow 2A in FIG. 2 and in the direction indicated with arrow 2B in FIG. 2. Note that, ticket gate 40 may be configured or set to allow a person to pass through ticket gate 40 only in one direction of the directions indicated with arrows 2A and 2B. In this case, face authentication camera 11 may be provided at ticket gate 40 only for one direction of the two directions.

Surveillance camera 12 is installed, for example, above ticket gate 40 and captures an image (passageway image) including the passageway in ticket gate 40 from above ticket gate 40. The passageway image captured by surveillance camera 12 is outputted to, for example, terminal PC 20. Surveillance camera 12 may be a camera capable of capturing the entire passageway in ticket gate 40 from above. For example, a PTZ camera or an omnidirectional camera may be used as surveillance camera 12. Further, surveillance camera 12 is not necessarily required to be configured integrally with ticket gate 40 or to be located directly above the passageway. Surveillance camera 12 may be disposed anywhere as long as the entire passageway in ticket gate 40 is included in the capture range of surveillance camera 12. For example, a camera installed on the ceiling of a train station in the vicinity of ticket gate 40 may also be used as surveillance camera 12.

As one non-limiting and exemplary of the installation form of surveillance camera 12, it is possible to mention an aspect in which support 42 of a pole type extending above ticket gate 40 is installed at ticket gate 40 and surveillance camera 12 is installed in an upper portion of support 42, for example, as illustrated in FIG. 2. The shape of support 42 is not limited to that of the pole type, but may be, for example, any other shape such as that of an arch type. Further, support 42 is not necessarily required to be support 42 dedicated to install surveillance camera 12. For example, an existing facility around ticket gate 40 may also be diverted as support 42 for functioning as support 42.

Terminal PC 20, for example, transmits information on a face image inputted from face authentication camera 11 to server 30 and requests server 30 to perform face authentication. Further, terminal PC 20 controls the opening and closing of ticket gate (gate) 40 in response to a face authentication result from server 30.

For example, in a case where a face authentication result indicates an authentication success (OK), terminal PC 20 controls ticket gate 40 such that ticket gate 40 is in an open state to allow a person to pass therethrough. In a case where a face authentication result indicates an authentication failure (NG), on the other hand, terminal PC 20 controls ticket gate 40 such that ticket gate 40 is in a closed state to regulate the passage of a person. Note that, terminal PC 20 may perform, in addition to the opening/closing control of ticket gate 40, control of outputting or displaying speech in response to a face authentication result, to ticket gate 40.

Further, as already described above, terminal PC 20, for example, detects whether a person has entered each division area of a passageway image of ticket gate 40 captured by surveillance camera 12, and determines based on a time-series change in a detection result thereof whether the person has passed through ticket gate 40. A result of the above determination (hereinafter may also be referred to as “passage determination”) may be managed, for example, in association with a face authentication result of a person according to the passage determination. This management makes it possible to manage, for example, whether a person who has succeeded in face authentication surely has passed through ticket gate 40.

For example, in a case where server 30 receives a request for face authentication from terminal PC 20, server 30 determines whether a face image that matches a face image received from terminal PC 20 is included in a database (DB) that stores face images of a plurality of persons registered in advance, and returns a determination result thereof (in other words, a face authentication result) to terminal PC 20.

Note that, the preregistration of face images in server 30 may be performed via a terminal for face image registration or may be performed directly to server 30 as illustrated in FIG. 1, for example.

Ticket gate 40, for example, receives the opening/closing control based on a face authentication result from terminal PC 20 to thereby allow or regulate the entry or exit of a person to or from the premises of a train station.

### [Configuration of Terminal PC 20]

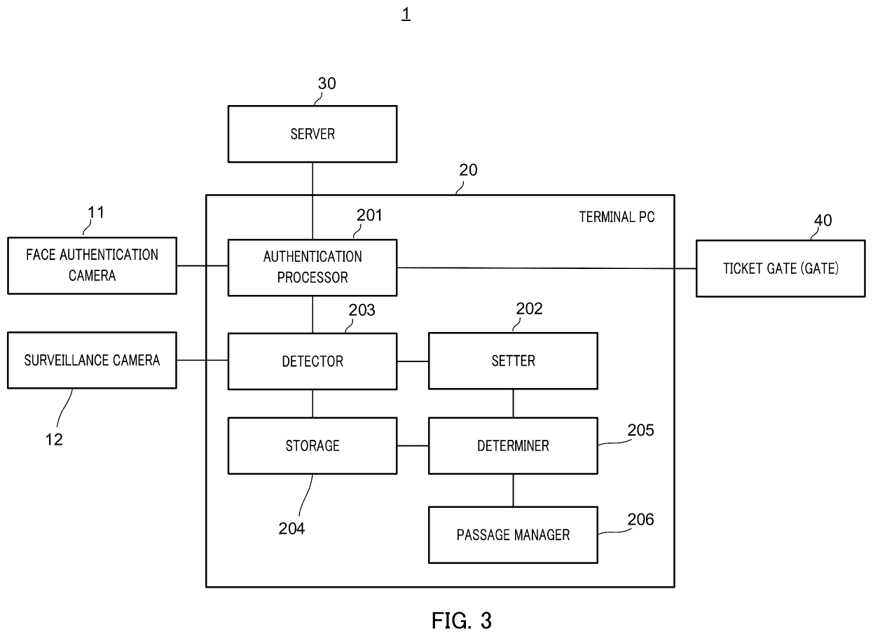

Next, a configuration example of terminal PC 20 will be described with reference to FIG. 3. FIG. 3 is a block diagram illustrating a configuration example of terminal PC 20. As illustrated in FIG. 3, terminal PC 20 may include, for example, authentication processor 201, setter 202, detector 203, storage 204, determiner 205, and passage manager 206.

Authentication processor 201, for example, detects (or extracts) a region corresponding to the face of a person (hereinafter which may also be referred to as “face region”) in an image received from face authentication camera 11 by image processing, and transmits information on the detected face region to server 30 to request server 30 to perform face authentication. Note that, the information on the face region, for example, may be an image of the face region or may be information indicating a characteristic point(s) extracted from an image of the face region.

Further, for example, in a case where authentication processor 201 receives a face authentication result from server 30, authentication processor 201 performs the opening/closing control of ticket gate 40 based on the received face authentication result. Further, authentication processor 201 may output a face authentication result received from server 30 to passage manager 206 in order to manage whether a person who has succeeded in the face authentication has passed through ticket gate 40.

Setter 202 sets, for example, a plurality of division areas obtained by dividing the passageway in a passageway image of the ticket gate captured by surveillance camera 12 into the plurality of division areas.

Detector 203 detects, for example, whether a person has entered each division area of a passageway image of ticket gate 40 received from surveillance camera 12, by image processing. For example, detector 203 may detect which division area a person has entered by comparing a passageway image captured by surveillance camera 12 with a passageway image in a stationary state.

The detection operation of detector 203 may be started, for example, in response to the start of the authentication processing by authentication processor 201. In this case, the operation time of detector 203 can be reduced, which therefore contributes to power saving of terminal PC 20.

A passageway image in a stationary state may be set to detector 203 by, for example, setter 202. The division area (person detection area) in which the entrance of a person is detected may be stored, for example, in time series in storage 204.

Determiner 205 determines, for example, based on information on a person detection area stored in time series in storage 204, whether a person has passed through ticket gate 40. For example, determiner 205 may determine that a person has passed through ticket gate 40 in a case where the person detection area changes in sequence over time from an area corresponding to the entrance of ticket gate 40 to an area corresponding to the exit of ticket gate 40.

For example, in a case where the person detection area does not change in sequence over time, on the other hand, determiner 205 may determine that the person has not passed through ticket gate 40. For example, as will be described later, in a case where a person who has entered ticket gate 40 from the entrance thereof remains in ticket gate 40 or in a case where a person has entered ticket gate 40 from the entrance thereof, but has gone back in the opposite direction and has exited from the entrance, it may be determined that the person has not passed through ticket gate 40.

Passage manager 206 manages (for example, stores), for example, information on a person, whose authentication processing result has been obtained in authentication processor 201, in association with a result of passage determination by determiner 205. Thus, for example, it is managed whether a person who has succeeded in authentication has passed through ticket gate 40.

Note that, one, some or all of function processors 201 to 206 of terminal PC 20 may be provided in, for example, server 30. Further, the face authentication processing by server 30 may be performed at terminal PC 20.

In other words, processing related to the face authentication and passage determination (or passage management) of a person as described above may be performed dispersedly by cooperation or a coordinated operation between terminal PC 20 and server 30 or may be performed intensively at terminal PC 20 or server 30. Further, terminal PC 20 and server 30 may be integrated into one information processing apparatus.

Further, persons to be subjected to the face authentication and passage determination are not limited to persons who move on their own, but may include, for example, persons who move on a vehicle such as a wheelchair (irrespective of whether the wheelchair operates manually or automatically (for example, electrically)).

### Operation Examples

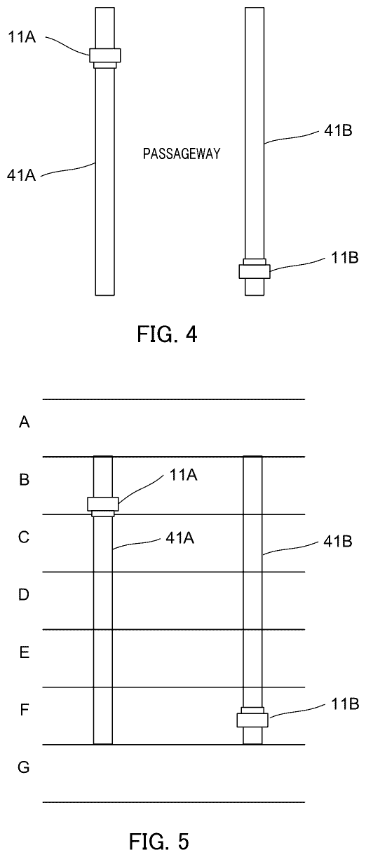

Next, operation examples of passage management system 1 will be described with reference to FIGS. 4 to 18.

FIG. 4 illustrates an example of a passageway image captured by surveillance camera 12. FIG. 5 illustrates an example in which a plurality of areas (or zones) A to G is set for the passageway image exemplified in FIG. 4. Terminal PC 20 (for example, detector 203) performs entrance detection of a person for each of areas A to G.

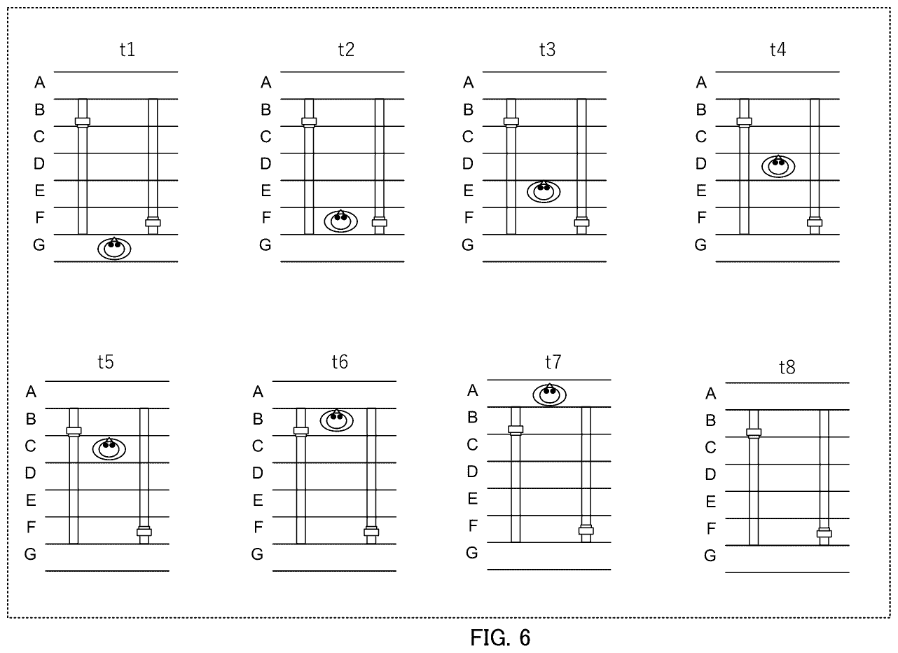

For example, in a case where a person advances from area G to area A as illustrated in FIG. 6, the entrance of the person to each individual area is detected in the order of areas G→F→E→D→C→B→A according to a time lapse from times t1 to t7. In other words, the person detection area changes (or transitions) in the order of areas G→F→E→D→C→B→A according to a time lapse from times t1 to t7.

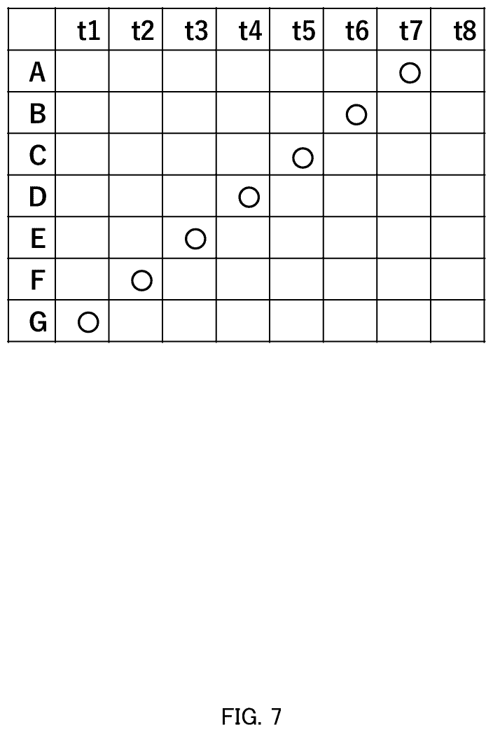

The relationship between the time lapse (from t1 to t7) and the person detection area in this case can be expressed as positions with the horizontal axis as the time axis and the vertical axis as the division area, for example, as illustrated in FIG. 7. In a case where the person detection area changes linearly according to the time lapse from t1 to t7 as illustrated in FIG. 7, it can be seen that a person who has entered ticket gate 40 has moved in ticket gate 40 in one direction during a period of time from times t1 to t7.

Here, for example, as illustrated in FIG. 7, in a case where area B has been set as the passage determination area in which it is determined that a person has passed through ticket gate 40, terminal PC 20 (for example, determiner 205) determines that a person has passed through ticket gate 40 normally at time t6. Note that, the passage determination area may be set by, for example, setter 202. For example, charging processing of charging the person may be executed in response to the determination of a normal passage.

The charging processing may be performed, for example, at terminal PC 20 or at an apparatus (for example, server 30) different from terminal PC 20 upon a request from terminal PC 20. Note that, a result of passage determination by terminal PC 20 (for example, determiner 205) may be used for recording or managing a passage involving no charging processing.

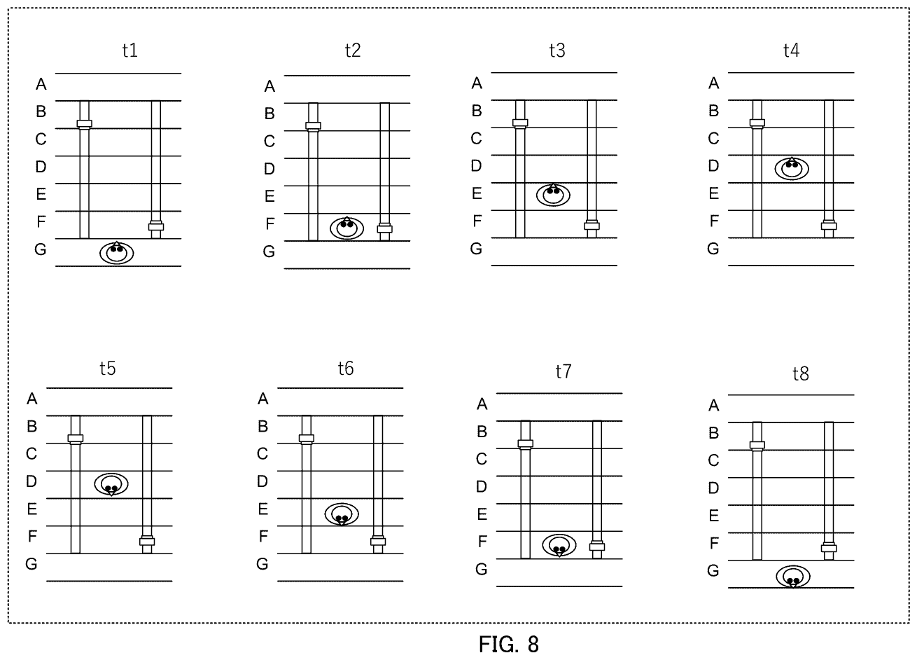

In contrast thereto, for example, FIG. 8 illustrates a case where a person who has entered ticket gate 40 has gone back in the middle in ticket gate 40. FIG. 8 illustrates an example in which a person who has entered ticket gate 40 from area Gat time t1 has reversed the advancing direction during a period of time from times t4 and t5 and has returned to area G at time t8.

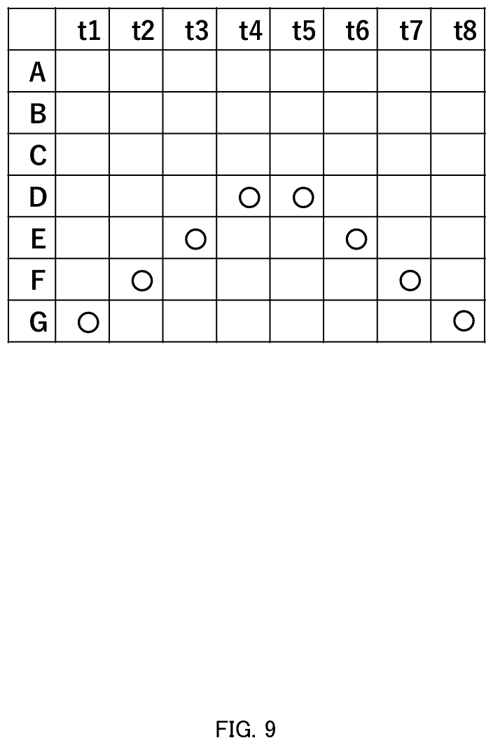

The relationship between the time lapse (from t1 to t8) and the person detection area in this case is illustrated in FIG. 9, for example. In a case where the person detection area changes non-linearly (in a mountain shape) according to the time lapse from t1 to t8 as exemplified in FIG. 9, it can be seen that a person who has entered ticket gate 40 has gone back in the middle (for example, in area D) in ticket gate 40 and has exited ticket gate 40 (that is, has not passed through ticket gate 40).

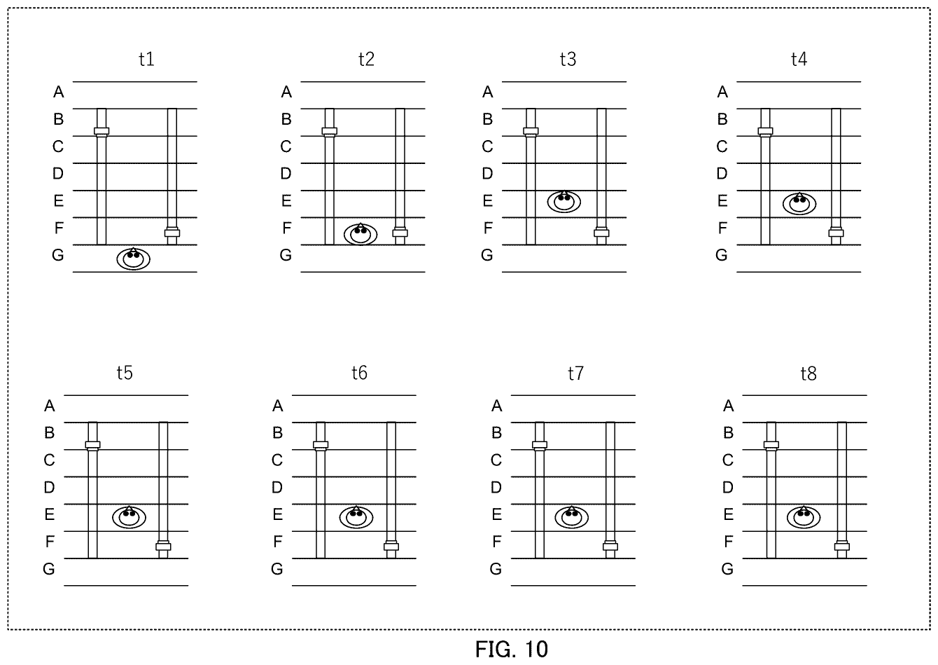

Further, for example, FIG. 10 illustrates a case where a person who has entered ticket gate 40 remains in the middle in ticket gate 40. FIG. 10 illustrates an example in which a person who has entered ticket gate 40 from area G at time t1 has reached area E together with a time lapse from times t2 to t3, but has remained in area E during a period of time from times t3 to t8.

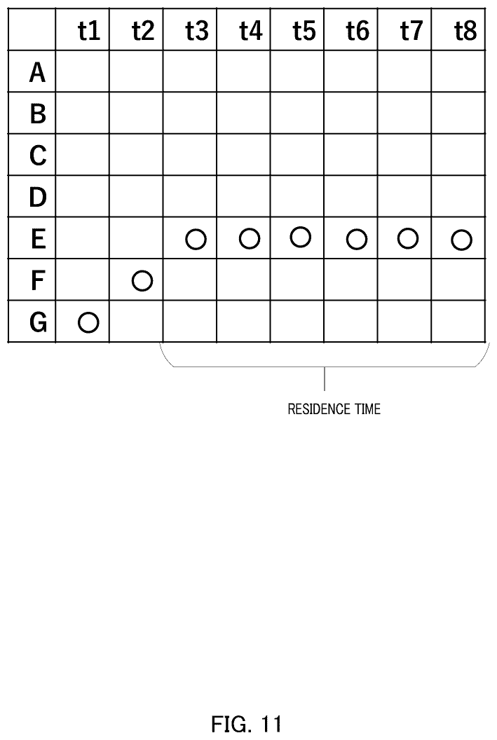

The relationship between the time lapse (from t1 to t8) and the person detection area in this case is illustrated in FIG. 11, for example. As exemplified in FIG. 11, the time during which the person detection area does not change (for example, from t3 to t8) indicates that a person who has entered ticket gate 40 resides in the middle (for example, in area E) in ticket gate 40 (that is, has not passed through ticket gate 40).

### [Passage Determination of a Plurality of Persons]

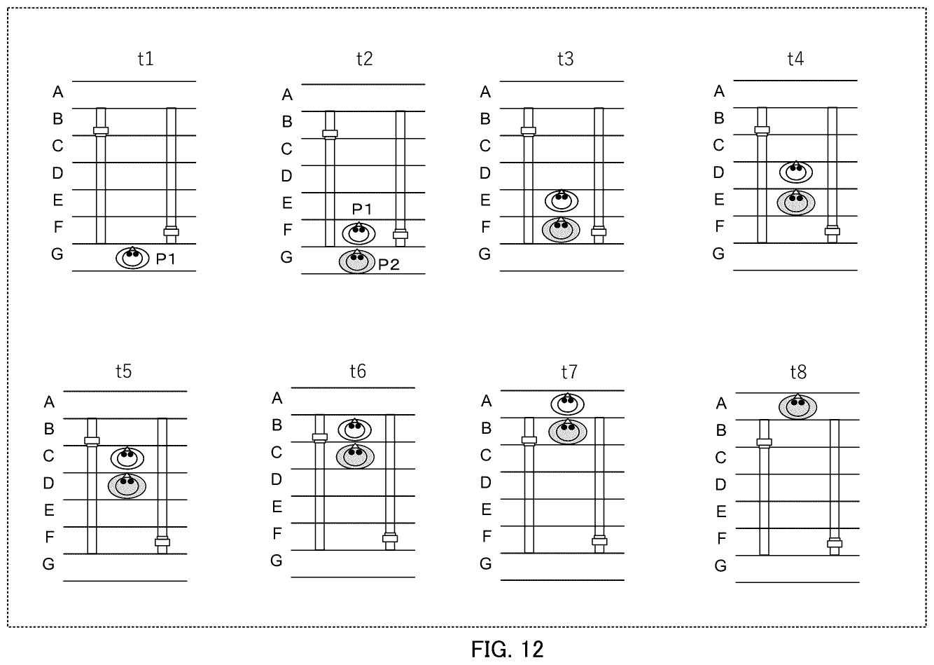

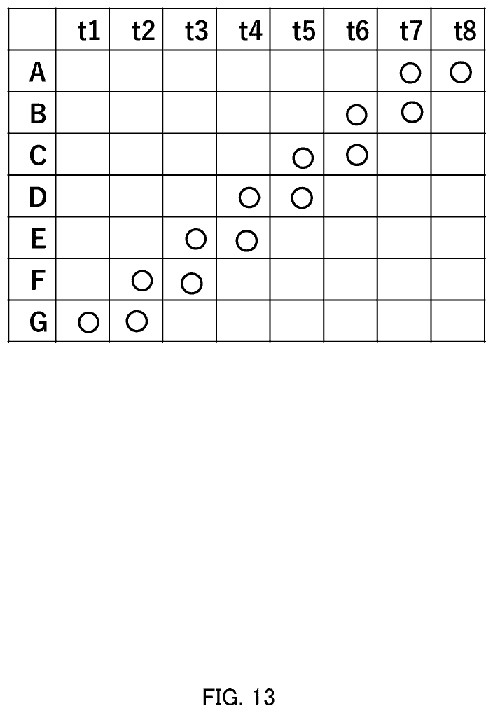

Next, FIGS. 12 to 15 illustrate cases where a plurality of persons has entered ticket gate 40. FIG. 12 illustrates a case where two persons P1 and P2 pass in sequence through ticket gate 40, and FIG. 13 illustrates an example of the relationship between a time lapse (from t1 to t8) and the person detection areas in the case of FIG. 12.

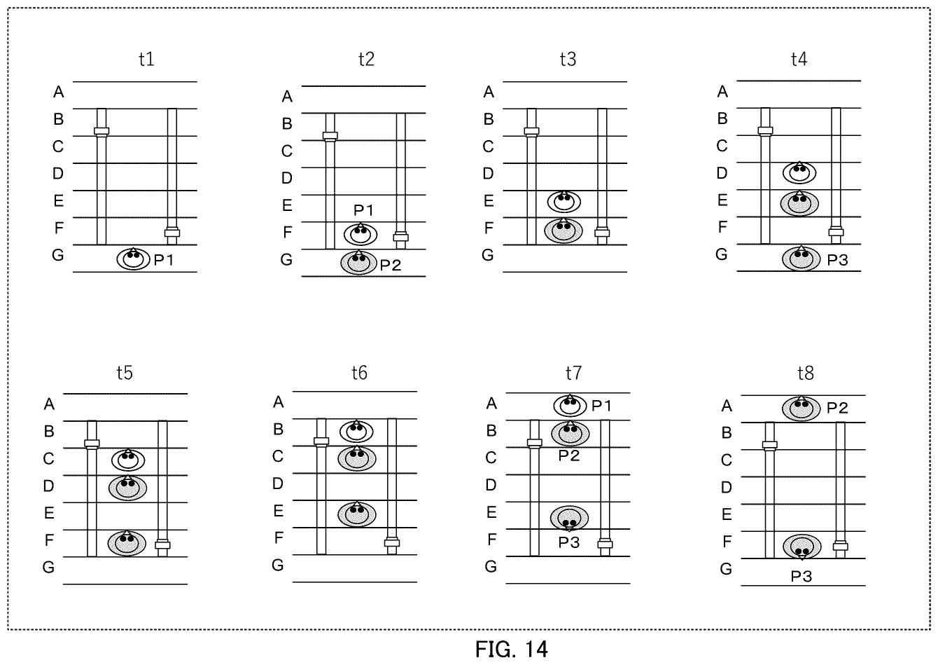

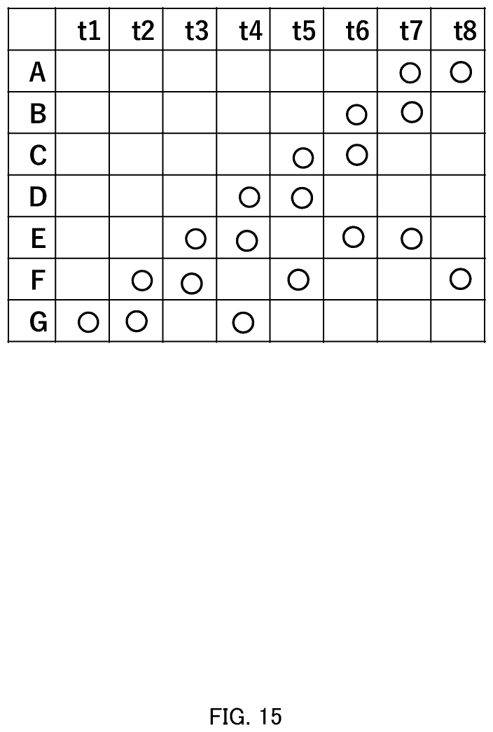

Further, FIG. 14 illustrates a case where three persons P1 to P3 have entered ticket gate 40, two persons P1 and P2 have passed through ticket gate 40 normally, but person P3 has gone back in ticket gate 40. FIG. 15 illustrates an example of the relationship between a time lapse (from t1 to t8) and the person detection areas in the case of FIG. 14.

In the case of FIG. 12, a person detection area changes in the order of areas G→F→E→D→C→B→A during a period of time from times t1 to t7 and a person detection area changes in the order of areas G→F→E→D→C→B→A during a period of time from times t2 to t8, which are later than time t1, as exemplified in FIG. 13.

In the present embodiment, the width of the passageway in ticket gate 40 is sufficiently narrow, and thus, it may be considered that replacement of a person at the front with a person at the rear does not occur. Accordingly, it can be determined that the linear change in the person detection area starting from time t1 corresponds to person P1, and that the linear change in the person detection area starting from time t2 corresponds to person P2.

Further, in the case of FIG. 14, linear changes in the person detection areas equivalent to those in the example in FIG. 13 appear during a period of time from times t1 to t7 and during a period of time from times t2 to t8, respectively, and the person detection area changes in the order of G→F→E→E→F during a period of time from times t4 to t8 and a mountain-shaped change appears, as exemplified in FIG. 15.

Accordingly, it can be determined that the two linear changes in the person detection areas, which start from times t1 and t2, respectively, corresponds to persons P1 and P2 who have passed through ticket gate 40 normally, respectively, and that the mountain-shaped change in the person detection area, which starts from time t4, corresponds to person P3 who has gone back in the middle in ticket gate 40.

As described above, even in a case where a plurality of persons has entered ticket gate 40, terminal PC 20 can distinguish the state of passage through ticket gate 40 for each of the plurality of person by following time-series changes in person detection areas.

### [Examples of Operation Flow]

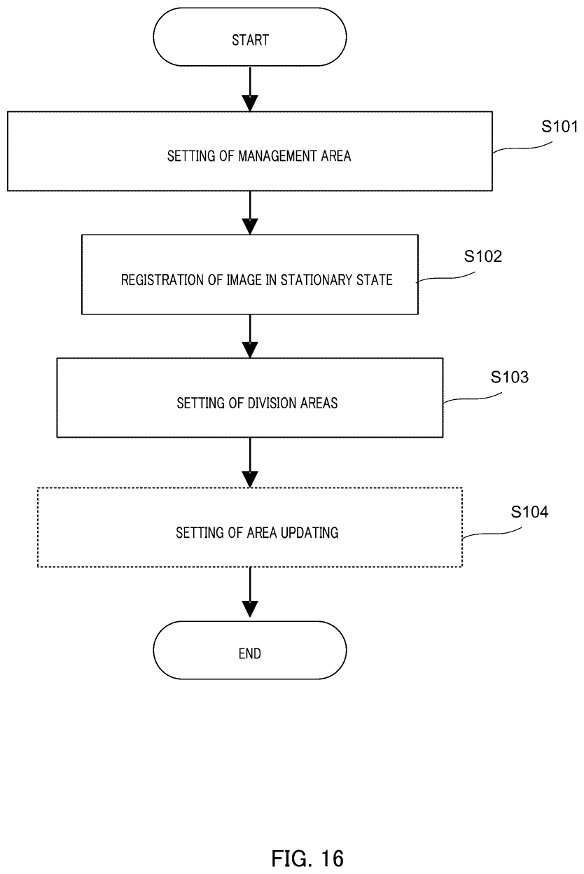

Next, the foregoing operation examples of terminal PC 20 will be described with reference to the flowcharts exemplified in FIGS. 16 to 18.

### [Pre-Setting]

As exemplified in FIG. 16, terminal PC 20, for example, uses setter 202 to set an area (a monitoring area or a capture area) to be monitored (in other words, to be captured) by surveillance camera 12 (S101). For example, setter 202 sets the monitoring area such that the entirety including the passageway of ticket gate 40 is included in the capture range.

Further, setter 202 sets (or registers), for example, an image, which is captured in a stationary state by surveillance camera 12, to (in) detector 203 (S102).

Further, setter 202 sets, for example, division areas (for example, areas A to G) for a passageway portion of the captured image of the monitoring area (S103).

Note that, the setting of each individual division area (for example, the width of ticket gate 40 in a direction along a direction in which a person travels in ticket gate 40) may be fixed or variable. In a case where the setting is variable, setter 202 may perform, for example, setting related to updating of the division areas to detector 203 (S104). Note that, in a case where the setting is variable, setter 202 may set division areas in response to an instruction from the user. In this case, various operations of the user can be considered. For example, the user may designate each division area manually or may designate the number of divisions, whereupon setter 202 divides the passageway portion at equal intervals to set division areas. Further, the setting of the passageway portion may also be fixed or variable. In a case where the setting is variable, setter 202 may set the passageway portion in response to an instruction from the user. Further, setter 202 may also detect information (for example, a marker, a specific background color, or the like) that allows the passageway portion to be identified from a captured image to specify the passageway portion automatically.

### [Operation]

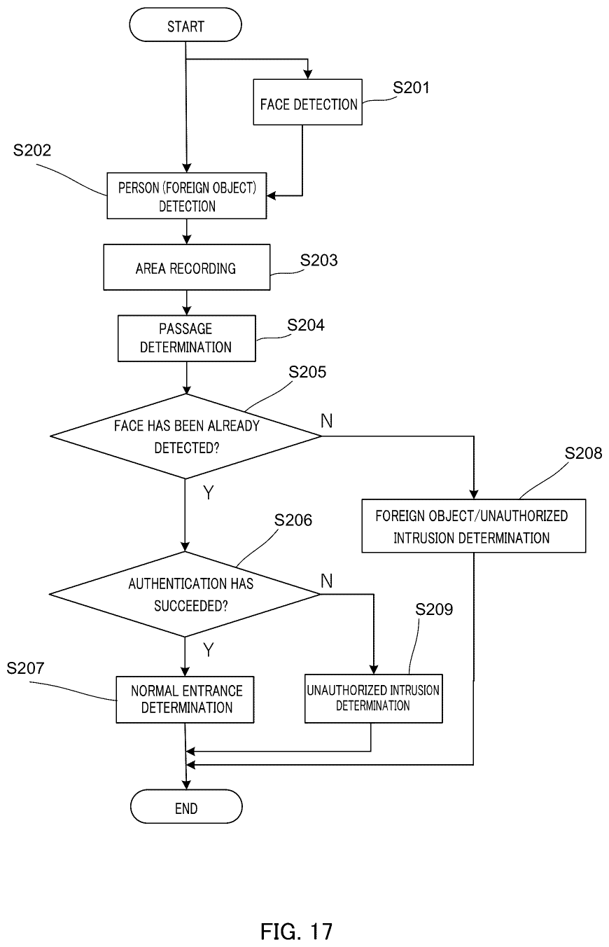

FIG. 17 is a flowchart illustrating an operation example of terminal PC 20 during operation of passage management system 1 after the pre-setting described above is completed.

As exemplified in FIG. 17, terminal PC 20 detects, for example, at authentication processor 201, a face region of a person in an image received from face authentication camera 11 by image processing during operation of passage management system 1 (S201). Note that, information on the detected face region is transmitted to, for example, server 30 as a request for face authentication.

Further, terminal PC 20 detects, for example, at detector 203, whether the person has entered for each division area by image processing (for example, foreign object detection), based on a passageway image of ticket gate 40 received from surveillance camera 12 and a passageway image in a stationary state (S202).

Detector 203 records (or registers) a detection result in S202 (for example, a person detection area(s)) in time series in storage 204 as exemplified in FIGS. 7, 9, 11, 13, and 15, for example (S203). Note that, the information or data recorded in storage 204 in the above-described manner may also be referred to as “time-series data” for convenience.

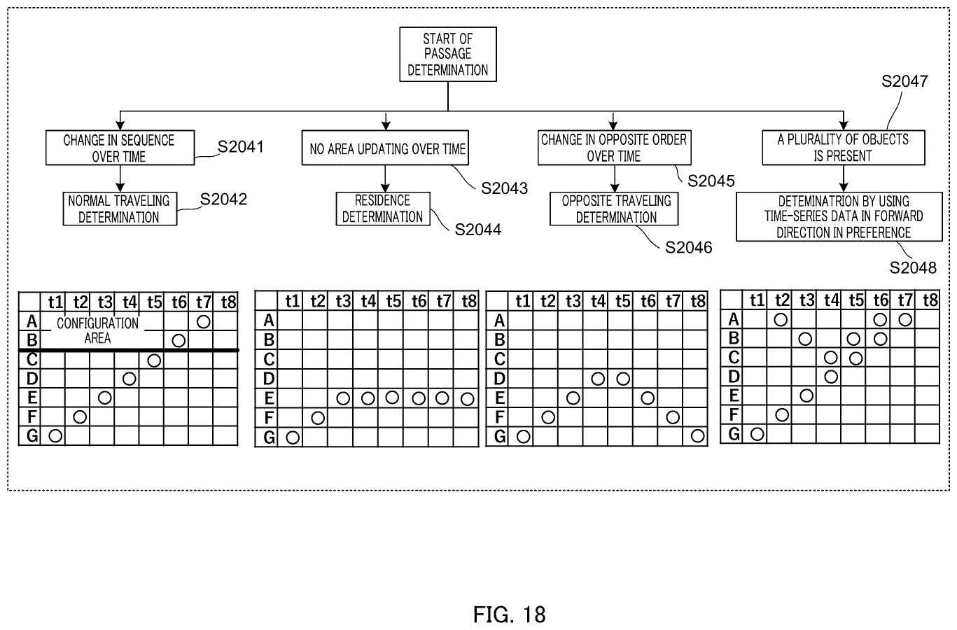

Thereafter, terminal PC 20 determines, for example, at determiner 205, whether the person has passed through ticket gate 40, based on the time-series data recorded in storage 204 (S204). An example of the above determination (passage determination) will be described later with reference to FIG. 18.

After the passage determined, terminal PC 20 confirms, for example, at authentication processor 201, whether the face region of the person who has entered ticket gate 40 has been already detected (S205). In a case where the face region of the person has been already detected (S205; Yes), authentication processor 201 confirms, for example, whether the face authentication has succeeded (S206).

For example, in a case where authentication processor 201 has received information indicating successful face authentication from server 30, authentication processor 201 may determine that the face authentication of the person whose face region has been detected in S201 has succeeded (S206; Yes).

In this case, for example, authentication processor 201 may determine that the person whose face region has been detected has entered ticket gate 40 normally (S207). Authentication processor 201 transmits, in response to the determination of the normal entrance, for example, a signal for controlling the gate to the open state to ticket gate 40 to allow the person, who has succeeded in the authentication, to pass through ticket gate 40.

In a case where authentication processor 201 has received information indicating unsuccessful face authentication from server 30, on the other hand, authentication processor 201 may determine that the face authentication of the person whose face region has been detected in S201 has failed (S206; No).

In this case, authentication processor 201 may determine, for example, that the person whose face region has been detected has entered ticket gate 40 without authorization (S209). Authentication processor 201 transmits, in response to the determination of the unauthorized entrance, for example, a signal for controlling the gate to the closed state to ticket gate 40 to regulate the passage of the person, who has failed in the authentication, through ticket gate 40.

Note that, in a case where the face region of the person has not been detected yet in S205 (S205; No), authentication processor 201 may determine, for example, that a foreign object that is not the person is present in the image captured by face authentication camera 11 or may determine an unauthorized intrusion (S208). Note that, no detection of the face region of the person due to a failure to detect the face region may occur as in a case where the person has entered, in a state in which his/her face is covered, ticket gate 40. In this case, the person whose face region has not been detected may be tracked and determination as in S208 may be performed, for example, by performing foreign object detection by using an image in the vicinity of the entrance of ticket gate 40 as a target region and switching the target region of the foreign object detection to an image including the entire region of the passageway with the foreign object detection as a trigger. Further, it may also be configured such that the foreign object detection is performed at all times, for example, regardless of whether the face region is detected (in other words, without the detection of the face region as a trigger).

### [Passage Determination]

Next, an operation example of the passage determination in S204 will be described with reference to FIG. 18.

As exemplified in FIG. 18, in a case where time-series data recorded in storage 204 indicate that a person detection area changes in sequence before reaching a passage determination area (for example, area B) (S2041), terminal PC 20 determines, for example, at determiner 205, that a person has passed through ticket gate 40 normally (passage completion) (S2042).

Further, for example, in a case where time-series data recorded in storage 204 indicate that a person detection area does not change (or is not updated) in an area (for example, area E) in the middle before reaching a passage determination area (for example, area B) (S2043), determiner 205 determines that a person remains in ticket gate 40 (residence determination) (S2044). In a case where the residence determination continues for a certain period of time (threshold time), determiner 205 may transmit, for example, a signal for issuing an alert to ticket gate 40.

Further, for example, in a case where time-series data recorded in storage 204 indicate that a person detection area changes in the opposite order in an area (for example, area D) in the middle before reaching a passage determination area (for example, area B) (S2045), determiner 205 determines that a person has gone back in the opposite direction in ticket gate 40 (opposite traveling determination) (S2046).

Note that, there is a case where time-series data recorded in storage 204 are present for a plurality of persons (S2047). For example, persons may enter ticket gate 40 bidirectionally during the same time slot. In this case, time-series data indicating changes of person detection areas in the forward direction and time-series data indicating changes of person detection areas in the opposite direction are recorded in storage 204.

For example, in a case where the passage in one direction at ticket gate 40 is set or assumed as the passage in the forward direction, determiner 205 may perform the determinations indicated in S2041 to S2046, for example, by using time-series data in the above-mentioned direction in preference to time-series data in the opposite direction (S2048).

For example, in a case where the direction from area G toward area A is the forward direction, determiner 205 may perform the passage determination by using time-series data, in which a person detection area changes in the order of areas G→F→E→D→C→B→A, in preference to time-series data, in which a person detection area changes in the order of areas A→B→C→B→A.

As described above, according to the embodiment described above, for example, it is determined, based on a change over time in a (division) area in which the entrance of a person is detected in a passageway image of ticket gate 40, whether the person has passed through the passageway of ticket gate 40. Accordingly, for example, it is possible to determine whether a person who has succeeded in face authentication has surely passed through ticket gate 40, and it is possible to improve the determination accuracy.

Further, it is possible to avoid a decrease in the detection accuracy due to a change or diversity in the environment around ticket gate 40 (for example, the color of the floor surface at the ticket gate, or external light) by using, for detecting a person in a division area, foreign object detection (which may also be referred to as “difference detection”) based on a passageway image and a passageway image in a stationary state, both of which are captured by surveillance camera 12, for example.

Further, for example, even in a case where the environment around ticket gate 40 varies for each ticket gate 40, special preparations, such as the capture environment is strictly adjusted and a library learned for person detection is prepared for each ticket gate 40, can be made unnecessary by difference detection using images captured by surveillance camera 12.

Further, in the embodiment described above, the passage determination is performed based on time-series movement of an object, which is considered to be a person, detected by foreign object detection using a background difference. Accordingly, it is possible to perform detection with less leakage than detection of a person himself/herself. In particular, a person wearing a hat or cap, who is difficult to detect with a library learned for detecting a “person”, or the like, can be surely detected as a “foreign object”, and thus, the embodiment described above makes is possible to realize the passage management even for persons who wear a variety of things.

Note that, as a similar mechanism, a mechanism is present in which ticket gate 40 is provided with numerous photoelectric sensors to directly detect the passage of an object, which is considered to be a person, through the passageway of ticket gate 40. However, this mechanism is incapable of detecting how far a person has passed through the passageway of ticket gate 40 without disposing numerous photoelectric sensors at ticket gate 40. For this reason, the configuration of the embodiment described above, which can realize the passage management when surveillance camera 12 capable of capturing the entire passageway is present, can suppress the required number of sensors more and is advantageous in terms of cost.

Accordingly, difference detection using images captured by surveillance camera 12 contributes to, for example, simplification of passage management system 1.

### [Variation 1]

In a case where the entire color of the passageway floor surface in ticket gate 40 is one uniform color in entrance detection (for example, foreign object detection) using images captured by surveillance camera 12 (in other words, images captured from above a person), a decrease in detection success rate may be assumed due to, for example, differences in hair colors of persons, clothes of persons, or things to wear on the head of persons, such as a hat or cap and a helmet.

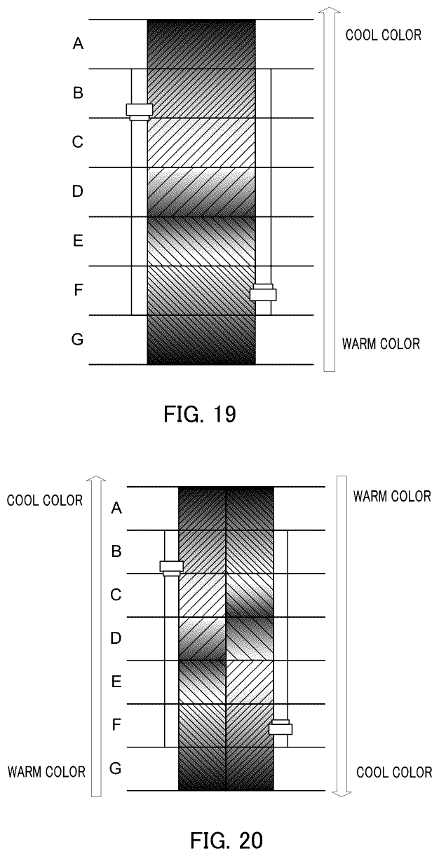

Accordingly, for example, the color of the passageway floor surface in ticket gate 40 may be partially different. For example, as illustrated in FIG. 19, zones of the passageway floor surface (which will be referred to as “floor surface zones” for convenience), which correspond to a plurality of division areas already described above (for example, areas A to G), respectively, may be subjected to the color coding for each of the floor surface zones.

As exemplified in FIG. 19, the color coding (which may also be referred to as “color arrangement”) may be, for example, color coding using a pattern (in other words, gradation) that stepwise changes for each of floor surface zones A to G. FIG. 19 illustrates an example in which the color changes stepwise from a warm color to a cool color, from floor surface zone A toward floor surface zone G. Note that, conversely, color coding in which the color changes stepwise from a warm color to a cool color, from floor surface zone G toward floor surface zone A may be applied to floor surface zones A to G.

For example, in the entrance detection for each division area using images captured from above a person, such color coding of the passageway floor surfaces can create a situation in which, even when the detection of the person is likely to fail in a floor surface zone of a specific color, the detection is likely to succeed in a floor surface zone of another color, in comparison with a case where the color of the passageway floor surface is one uniform color. Accordingly, it is possible to reduce the probability of failing in entrance detection (in other words, it is possible to improve the detection success rate) of a person who travels on the passageway of ticket gate 40.

Alternatively, for example, as illustrated in FIG. 20, the color coding may have an aspect in which a stepwise color change varies for each division area in the passageway width direction in a case where the passageway floor surface is divided in the passageway width direction (divided into two portions in the case of FIG. 20).

For example, FIG. 20 illustrates an example in which a stepwise color change in the opposite order with respect to a stepwise color change applied to one portions (for example, on the left side) of areas each of which is divided into two portions in the passageway width direction is applied to the other portions (for example, on the right side) of the areas each of which is divided into the two portions in the passageway width direction. For example, color coding in which the color changes stepwise from a warm color to a cool color, from floor surface zone A toward floor surface zone G, in the same manner as in FIG. 19 may be applied to those on the left side, and color coding in which the color changes stepwise from a warm color to a cool color, from floor surface zone G toward floor surface zone A, may be applied to those on the right side.

Such color coding can create a situation in which, for example, in a case where a person has passed through ticket gate 40 in the forward direction and then another person passes through ticket gate 40 in the opposite direction, the detection is likely to succeed with floors zones of different colors, both in the forward and opposite directions. Accordingly, it is possible to reduce the probability of failing in the entrance detection (in other words, it is possible to improve the detection success rate) of even a person who travels on the passageway of ticket gate 40 in any direction of the forward and opposite directions.

Note that, the color coding of the passageway floor surface may not be stepwise (or gradation), but may be, for example, giving different colors to floor surface zones, respectively. The “color coding” may also include giving no color to one or some of a plurality of floor zones.

Further, instead of or in addition to color (for example, hue), for example, at least one of brightness, colorfulness, and/or contrast may differ for one, some or all of a plurality of floor surface areas.

Note that, for convenience, the term “color coding” in the present disclosure may be understood to include an aspect in which at least one of hue, brightness, colorfulness, and/or contrast (which may also be referred to as “color parameter” with respect to at least one thereof for convenience) differs.

Further, the color coding of the passageway floor surface is not limited to physical techniques such as paint application, or arrangement of floor materials of different colors, and may be virtually realized using, for example, a technology such as projection mapping. For example, marks such as arrows indicating the traveling direction may be set on the passageway floor surface by projection mapping, and the marks may be displayed by color coding according to division areas.

Further, instead of color coding being given to the passageway floor surface, for example, a working effect equivalent to that attainable by the color coding described above may be realized by image processing. For example, in image processing, a specific color may be highlighted (or amplified) or attenuated for each division area or at least one of brightness, colorfulness, and/or contrast may be highlighted (or amplified) or attenuated for each division area.

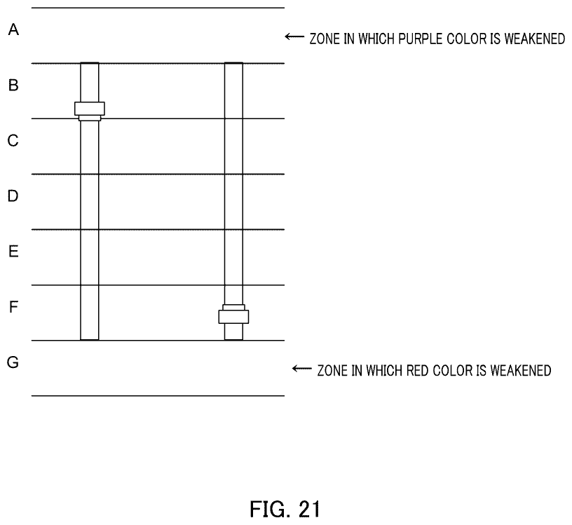

FIG. 21 illustrates, as one non-limiting and exemplary example, an example in which, among division areas A to G, the purple color is emphasized in division area A and the red color is attenuated in division area G.

Processing related to color coding using image processing as such may be set to detector 203 by setter 202, for example.

By realizing processing corresponding to color coding by image processing (or projection mapping), it is easy to introduce passage management system 1 because there is no need to apply special processing to the passageway floor surface.

Further, even in a case where there is a difference in hair color or in terms of whether persons have things to wear, the color coding of the floor surfaces of division areas or the color coding by image processing makes it possible to improve the detection success rate of detecting a person in one division area. Accordingly, the passage determination or tracking accuracy of a person at ticket gate 40 can be improved in comparison with a case where no color coding is applied.

### [Variation 2]

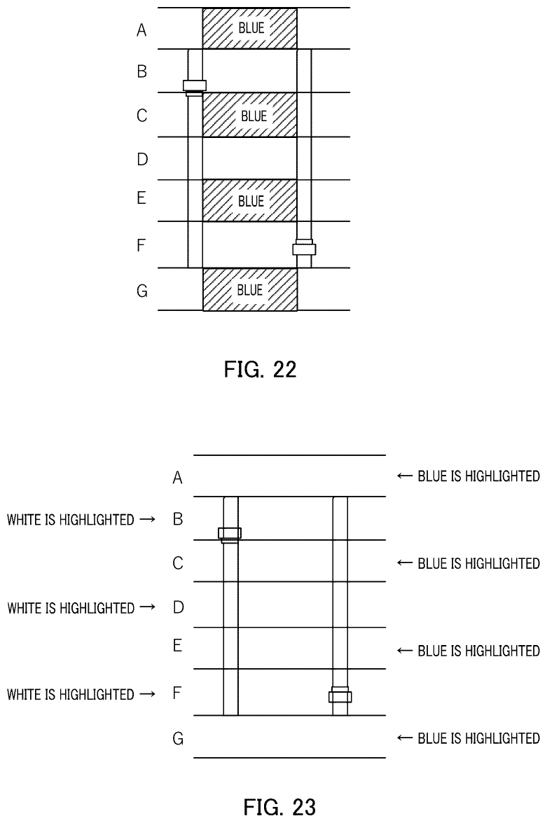

Further, the color coding of the passageway floor surface may be a stripe shape of alternating two colors (for example, the blue color and the white color) as illustrated in FIG. 22, for example. In other words, the color of the passageway floor surface may be changed periodically for each floor surface area. Note that, the color of the passageway floor surface may be changed periodically with three or more colors. The periodic color combination given to the passageway floor surface may be a combination of arbitrary different colors.

According to such periodic color coding, a floor surface area of the same color appears periodically in image processing as a person travels. Accordingly, for example, it is possible to estimate, for even a person whose detection is likely to fail in a floor surface area of a specific color, a change in the position of the person at ticket gate 40 by tracking a change in the entrance detection area in time series.

For example, in FIG. 22, in a case where a person is detected in the order of floor surface zone F of the white color→floor surface zone D of the white color and then the person is not detected in floor surface zone B of the white color, it is possible to estimate that “a person whose detection is likely to fail in a floor surface of the blue color is highly likely to be located in zone C of ticket gate 40”.

Note that, the periodic color coding described above may also be realized in the same manner as Variation 1, for example, by periodically changing, in image processing, a color parameter that is periodically emphasized or attenuated. As one non-limiting and exemplary example, it is also possible to alternately set a zone, in which the blue color is emphasized, and a zone, in which the white color is emphasized, as illustrated in FIG. 23.

Further, in a case where three or more colors are used, the order of the colors that are used in each period may be arbitrary as long as a set of colors to be used appears periodically. For example, it is possible to consider that a first period (blue, red, and white), a second period (red, white, and blue), . . . are configured. Even in this configuration, it is expected that a person is detected at least once in each period, and thus, a change in the entrance detection area can be tracked in time series. In the example described above, for example, a person who can only be detected with the white color is detected at the last of the first period and at the center of the second period. As a result, it can be seen that the person has moved from the region of the first period to the region of the second period in time series.

In the same manner as the color coding of the passageway floor surface, such periodic color coding by image processing also makes it possible to estimate, for even a person whose detection is likely to fail in a floor surface area of a specific color, a change in the position of the person at ticket gate 40 by tracking a change in the entrance detection area in time series.

### [Variation 3]

In the embodiment described above, it is assumed that a passageway image in a stationary state may be acquired in a state in which no person is present on the passageway of ticket gate 40. In the case of a non-stationary state, for example, in a case where surveillance camera 12 is fixed, however, a passageway image captured in a state (for example, after the operation starts) in which a person is present on the passageway of ticket gate 40 (for example, passes therethrough) may be set as a passageway image in a stationary state.

For example, an image obtained by removing a moving body/bodies therefrom by superimposing images (for example, frames) captured at a plurality of timings by surveillance camera 12 to take a difference therebetween may be set as a passageway image in a stationary state.

### [Variation 4]

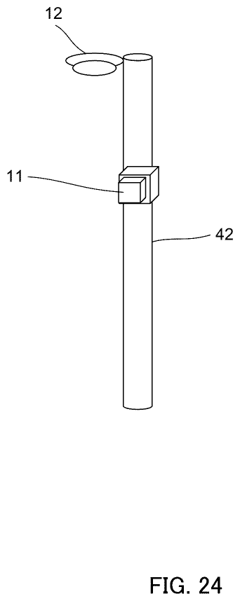

In the configuration illustrated in FIG. 2, an aspect in which face authentication camera 11 is provided in one or both of side walls 41A and 41B of ticket gate 40 has been exemplified, but face authentication camera 11 may be installed in a position(s) in which a range including the face of a person who enters ticket gate 40 can be captured. For example, as illustrated in FIG. 24, it may be configured such that face authentication camera 11 is provided in support 42 provided with surveillance camera 12.

### [Variation 5]

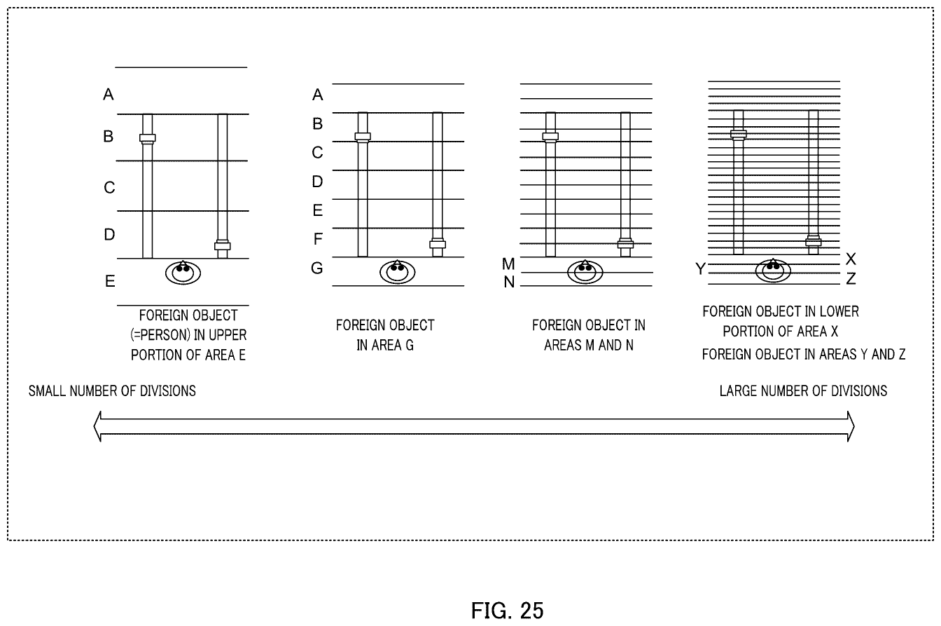

The size of the division area (for example, the width of ticket gate 40 in the direction along the direction in which a person travels in ticket gate 40), in other words, the number of division areas in the direction along the passageway of ticket gate 40 may be arbitrary. For example, as illustrated in FIG. 25, the size of the division area may be one of a size larger than the average size of persons (hereinafter which may also be referred to as “person size”), a size comparable to the average size of persons, and a size smaller than the average size of persons.

In a case where the size of the division area is larger than the average size of persons, for example, it is possible to estimate the position of a person to be detected in ticket gate 40 based on the coordinates of the person on an image. In a case where the size of the division area is smaller than the average size of persons, for example, a person is detected across a plurality of division areas, and thus, combining processing of the plurality of division areas mentioned above into one entrance detection area may be performed.

When the division area is set to have a size corresponding to the average size of persons (hereinafter which may also be referred to as “person size”), it is easy to grasp each individual traveling situation without using processing such as tracking of coordinates and combining division areas additionally. Thus, for example, as exemplified in FIGS. 12 to 15, it is also easy to grasp each individual traveling situation in a case where a plurality of person enters ticket gate 40.

### [Variation 6]

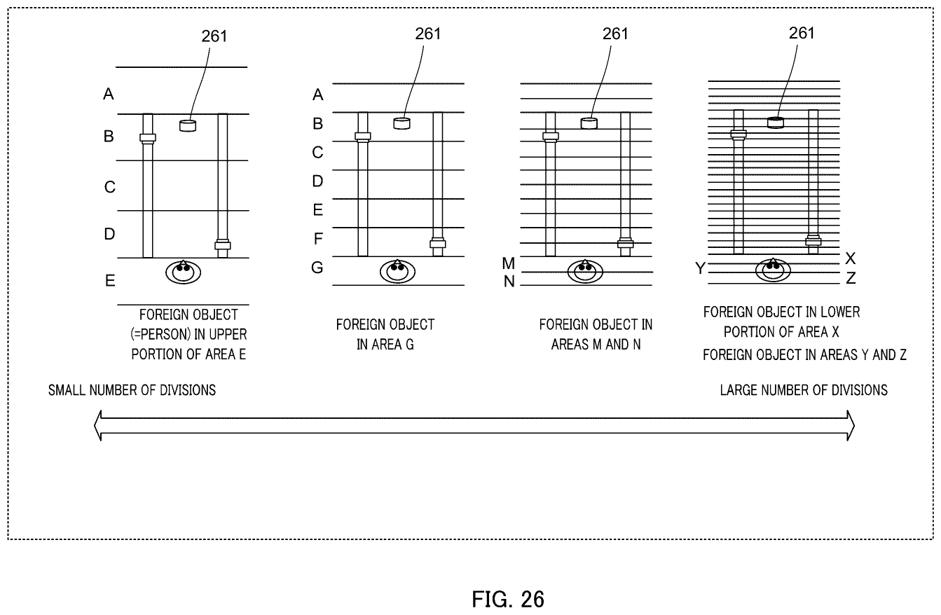

Further, for example, as illustrated in FIG. 26, even in a case where object 261 such as trash, which is unintended, is captured in a passageway image of ticket gate 40, object 261 that is unintended can be easily excluded from those to be subjected to the entrance detection by setting the division area to have an appropriate size (for example, a size corresponding to the person size). For example, determiner 205 may determine whether a foreign object is a person based on the size of the foreign object in a passageway image. That is, objects that are too small or too large in comparison with the division area can be determined to be objects 261 that are not persons. Determiner 205 may not use a foreign object, which has been determined not as a person, in determination as to whether a person has passed through the passageway.

Alternatively or additionally, object 261 may be excluded depending on whether the face authentication processing has been performed. For example, object 261 detected when the face authentication processing has not been performed may be determined not as a person and excluded from those to be subjected to the entrance detection.

### [Variation 7]

The size of the division area (for example, the width of the passageway in the direction along the traveling direction of the passageway) may not be uniform for all, one or some of a plurality of division areas. For example, the size of one, some or all of a plurality of division areas may be set to different sizes according to the position of a person in a passageway image.

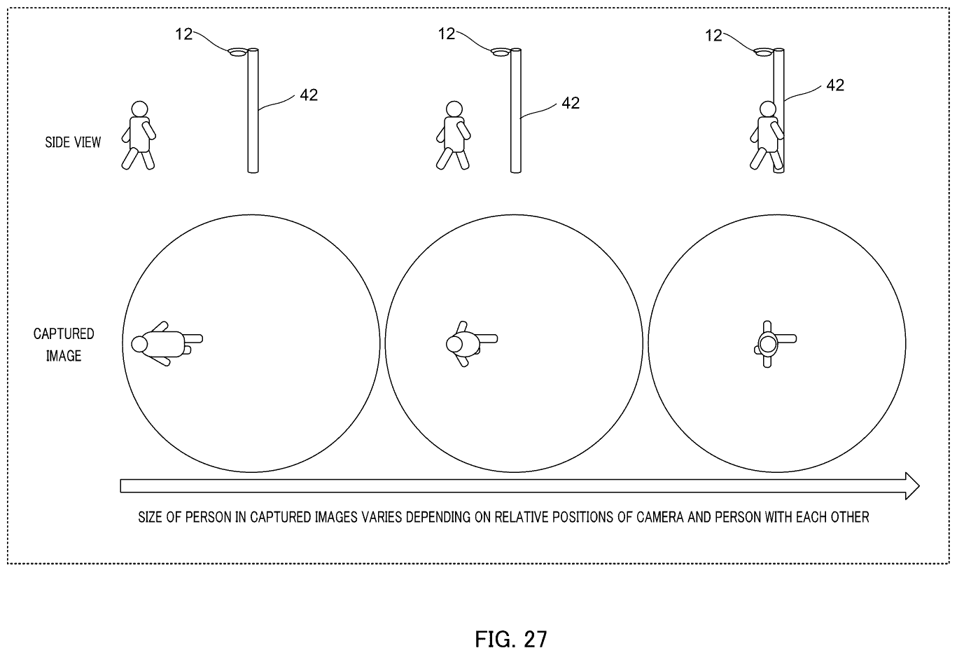

For example, as illustrated in FIG. 27, the size of a region occupied by a person in an image captured by surveillance camera 12 may vary depending on the position of the person with respect to surveillance camera 12. For example, as illustrated in the upper stage in FIG. 27, the closer the person is to surveillance camera 12, the smaller the size of the person in an image captured by surveillance camera 12 may be as illustrated in the lower stage in FIG. 27.

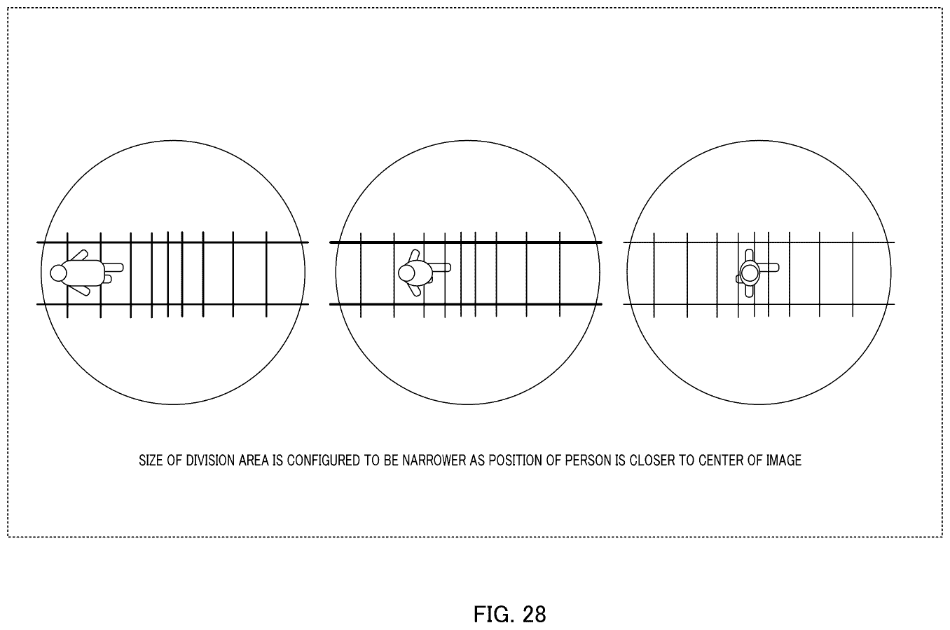

For this reason, for example, as illustrated in FIG. 28, the size of the division area may be set to be smaller (or narrower) as the position of the division area is closer to the disposition position of surveillance camera 12 (for example, the center of a region captured by surveillance camera 12).

For example, the size of the division area may be non-uniformly set such that “a person is in one division area” or “a person is across a fixed number of division areas” in a case where the position of the person with respect to surveillance camera 12 changes.

As one non-limiting and exemplary example, FIG. 28 illustrates an example in which the size of the division area is set such that “a person is across three division areas” in a passageway image in each of different positions of the person with respect to surveillance camera 12. Note that, the number of division areas across which the person is in a passageway image may be four or more.

According to such a setting, the number of entrance detection areas for one person can be made constant in relation to the person size in a passageway image regardless of a change in the position of the person with respect to surveillance camera 12. Accordingly, for example, it is possible to obtain the same working effect as in Variation 5 by simpler image processing in comparison with a case where the size of the plurality of division areas is set to be uniformly constant.

Alternatively, the size of the division area may not be changed (or adjusted) and, for example, the number of division areas across which a person is or the proportion of the person size in each individual division area may be changed (or adjusted) depending on the position in which the person appears in a passageway image.

For example, the number of division areas across which one person is may be set to be smaller as the position of the division area is closer to the center of a region captured by surveillance camera 12, or the proportion of the person size in each individual division area having the same size may be set to be small.

### [Variation 8]

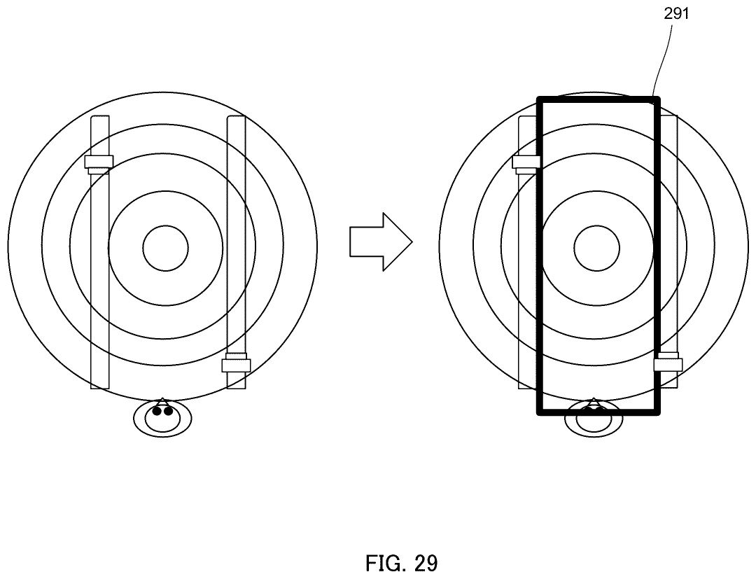

The lines that separate division areas in the traveling direction of a person may be straight or curved. For example, as illustrated in FIG. 29 (on the left side), the respective portions (in other words, arcs) of a plurality of concentric circles extending radially from a passageway center portion of ticket gate 40 may correspond to the lines that separate division areas in the traveling direction.

As exemplified with bold frame 291 in FIG. 29 (on the right side), the areas separated by the arcs located outside ticket gate 40 can be excluded from those to be subjected to the person detection by setting the areas separated by the individual arcs in the range in which the person travels with respect to ticket gate 40 as the division areas to be subjected to the person detection.

### [Variation 9]

In the embodiment including Variations 1 to 8 described above, the passageway to be subjected of the passage management is not limited to the passageway of ticket gate 40 installed at a train station. For example, the embodiment including Variations 1 to 8 described above may be applied to the passageway of a gate installed at various facilities or venues into which entrance/exit control may be introduced, such as an airport, a port, a commercial facility, a public facility, an amusement facility, a theme park, a park, and an event venue.

Further, the embodiment including Variations 1 to 8 described above may be applied to passage management in a gate having no function of performing opening/closing control.

### Complements to the Entire Embodiment

In the embodiment including Variations 1 to 8 described above, an example in which the passageway of ticket gate 40 (or a gate) is formed by side walls 41A and 41B (FIG. 2) that face each other has been indicated, but the present disclosure is not limited thereto. For example, the passageway may be set continuously or discontinuously by a member(s) such as a rope, a tape, and/or a pole each of which guides the travel of a person and separately from other areas. Further, instead of or in addition to such a physical member(s), the “passageway” for guiding a person may be set separately from other areas, for example, by using a virtual means such as projection mapping.

Further, the length of the passageway to be subjected to the passage determination may be arbitrary. For example, the length of the passageway may be longer than a generally assumed length for ticket gate 40 or a gate. For example, face authentication camera 11 may be installed at a location at which a region including the face of a person who intrudes into the passageway is in the capture range, and the passage determination area already described above may be set to an area in which a person exits the passageway.

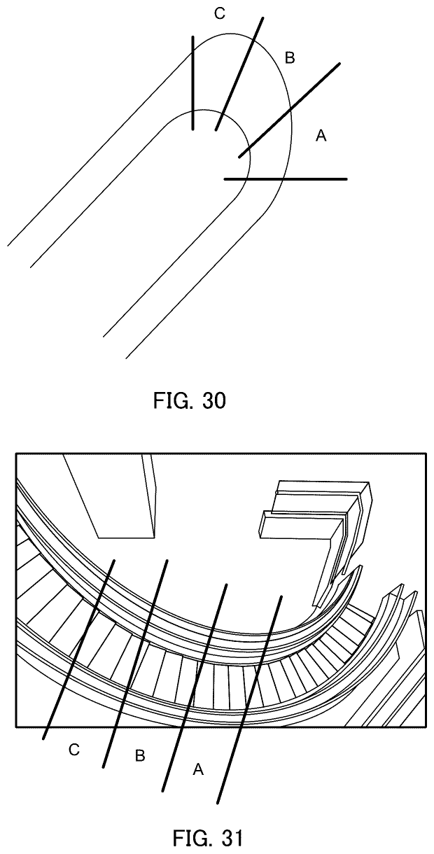

Further, the passageway to be subjected to the passage determination does not necessarily have a straight line shape, but may have a portion that is partially or entirely curved as illustrated in FIG. 30, or may have a difference in height (for example, a step(s) such as a staircase) partially or entirely. Further, the passageway may also be a stationary passageway or may be a moving passageway such as, for example, a moving sidewalk or an escalator. FIG. 31 illustrates a spiral escalator including a spiral movable passageway as one non-limiting and exemplary example of a passageway having a curved portion and a difference in height.

It is possible to surely determine whether a person has passed through the passageway, for example, without installing a plurality of physical sensors, such as human sensors, along the traveling direction of the passageway, by including the entire passageway in the capture range from above surveillance camera 12 regardless of the length of the passageway or irrespective of whether a part or all of the passageway includes a curved portion or has a difference in height. Note that, in this case, the division area may be set according to the shape of the passageway viewed from surveillance camera 12. For example, with respect to a curved portion, the division area is set according to the curvature of the curved portion, whereas with respect to a portion having a difference in height, a wider division area is set as the portion is closer to surveillance camera 12 according to perspective.

Note that, the number of surveillance cameras 12 is not limited to one. For example, the entire passageway may be captured by a plurality of surveillance cameras 12. In addition to partial passageway images captured by the plurality of surveillance cameras 12, division areas may be set to determine and manage the traveling situation of a person.

Although the embodiments have been described above with reference to the accompanying drawings, the present disclosure is not limited to such examples. It is obvious that a person skilled in the art can arrive at various variations and modifications within the scope described in the claims. It is understood that such variations and modifications also belong to the technical scope of the present disclosure as a matter of fact. Further, components in the embodiments described above may be arbitrarily combined without departing from the spirit of the present disclosure.

Further, the specific examples in the present disclosure are merely exemplary and do not limit the scope of the claims. The techniques described in the scope of the claims include various variations and modifications of the specific examples exemplified above.

Further, the expressions “ . . . processor”, “ . . . -er“,” . . . or“, and” . . . -ar” in the embodiments described above may be interchangeably replaced with other expressions such as “. . . circuitry”, “. . . device”, “. . . unit”, or “. . . module”.

The present disclosure can be realized by software, hardware, or software in cooperation with hardware. For example, the functions of the system described above can be realized by computer programs.

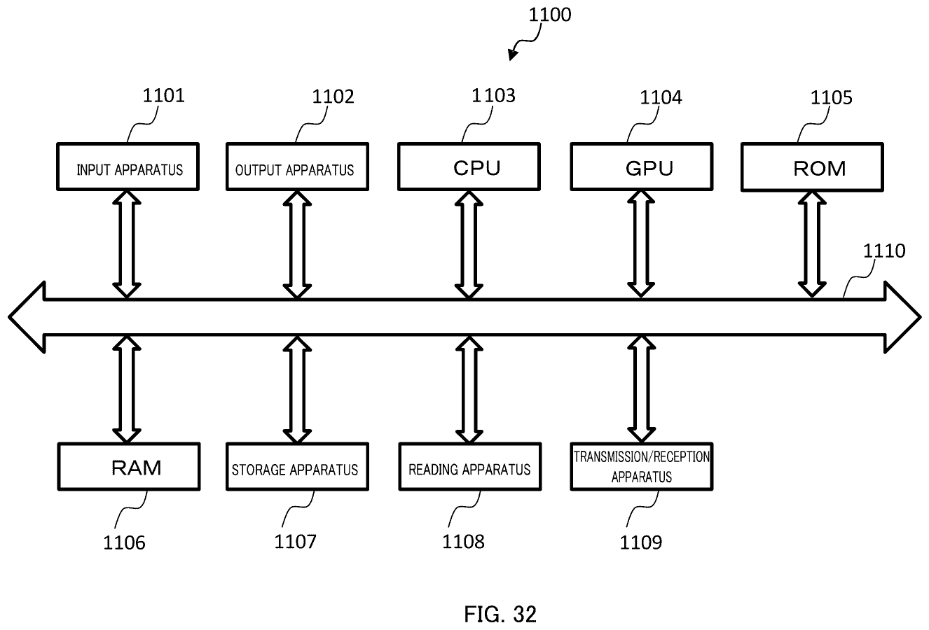

FIG. 32 illustrates a hardware configuration of a computer (or an information processing apparatus) that realizes the functions of each apparatus forming passage management system 1 described above by programs. In FIG. 32, computer 1100 includes: input apparatus 1101 such as a keyboard, a mouse, or a touch pad: output apparatus 1102 such as a display or a speaker: central processing unit (CPU) 1103: graphics processing unit (GPU) 1104; read only memory (ROM) 1105: random access memory (RAM) 1106; storage apparatus 1107 such as a hard disk apparatus or a solid state drive (SSD); reading apparatus 1108 that reads information from a recording medium such as a digital versatile disk read only memory (DVD-ROM) or a universal serial bus (USB); and transmission/reception apparatus 1109 that performs communication via a network. Each processor is connected by bus 1110.

Reading apparatus 1108 reads a program for realizing the function of terminal PC 20 from the recording medium that records the program, and causes storage apparatus 1107 to store the program, for example. Alternatively, transmission/reception apparatus 1109 communicates with a server apparatus (which may be server 30 or a server apparatus different from server 30) connected to the network, and causes storage apparatus 1107 to store programs for realizing the functions of each apparatus described above, which is downloaded from the server apparatus.

CPU 1103 copies a program stored in storage apparatus 1107 to RAM 1106 and sequentially reads instructions included in the program from RAM 1106 and executes the instructions, and thus, the function of terminal PC 20 according to the embodiment described above is realized.

Each functional block used in the description of the embodiments described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a radio transceiver and processing/control circuitry. The radio transceiver may comprise and/or function as a receiver and a transmitter. The radio transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a PC (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

In recent years, in Internet of Things (IoT) technology, Cyber Physical Systems (CPSs), which are a new concept of creating new added value by information cooperation between a physical space and cyberspace, has attracted attention. This CPS concept can also be adopted in the above embodiment.

That is, a basic configuration of the CPSs is, for example, such that an edge server disposed in the physical space and a cloud server disposed in the cyberspace can be connected to each other via a network, and processes can be distributedly processed by processors mounted in these servers. Here, it is preferable that pieces of processed data generated in the edge server or the cloud server be generated on a standardized platform. By using such a standardized platform, it is possible to efficiently build a system including various sensor groups and IoT application software.

The communication may include data communication through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

The disclosure of Japanese Patent Application No. 2021-107594, filed on Jun. 29, 2021, including the specification, drawings and abstract, is incorporated herein by reference in its entirety.

An one exemplary embodiment of the present disclosure is suitable for passage management of a passageway in a gate such as a ticket gate.

### REFERENCE SIGNS LIST

1 Passage management system
11 Face authentication camera
12 Surveillance camera
20 Terminal PC
30 Server
40 Ticket gate (gate)
41A, 41B Side wall
42 Support
201 Authentication processor
202 Setter
203 Detector
204 Storage
205 Determiner
206 Passage manager
1100 Computer
1101 Input apparatus
1102 Output apparatus
1103 CPU
1104 GPU (Graphics Processing Unit)
1105 ROM (Read Only Memory)
1106 RAM (Random Access Memory)
1107 Storage apparatus
1108 Reading apparatus
1109 Transmission/reception apparatus
1110 Bus

1. An information processing apparatus, comprising:
a detector that performs detection of a foreign object, in an image obtained by capturing a passageway from above, for each of a plurality of zones set to the passageway, the foreign object being an object not included in the image in a stationary state; and
a determiner that determines whether a person corresponding to the foreign object has passed through the passageway based on a change over time in a zone in which the foreign object is detected, among the plurality of zones.

2. The information processing apparatus according to claim 1, wherein
in a case where the change over time indicates that, among the plurality of zones, the zone in which the foreign object is detected changes in sequence between a zone corresponding to an entrance of the passageway and a zone corresponding to an exit of the passageway, the determiner determines that the person has passed from the entrance of the passageway to the exit of the passageway.

3. The information processing apparatus according to claim 1, wherein
in a case where the change over time indicates that an order of a plurality of the zones in which the foreign object is detected is reversed, the determiner determines that the person has gone back in the passageway.

4. The information processing apparatus according to claim 1, wherein
the determiner determines whether the foreign object is the person based on a size of the foreign object, and
the determiner does not use the foreign object which has been determined as not the person, in determination as to whether the person has passed through the passageway.

5. The information processing apparatus according to claim 1, wherein
the detector starts the detection in response to a start of authentication processing using a face image of the person.

6. The information processing apparatus according to claim 1, wherein
a floor surface of the passageway is subjected to color coding for each of the plurality of zones.

7. The information processing apparatus according to claim 6, wherein
the color coding is a pattern that changes stepwise for each of the plurality of zones.

8. The information processing apparatus according to claim 6, wherein
the color coding is a pattern in which a specific color appears periodically for each of the plurality of zones.

9. The information processing apparatus according to claim 1, wherein:
in the detection of the foreign object, the detector varies at least one of hue, brightness, colorfulness, and/or contrast for each of the plurality of zones.

10. The information processing apparatus according to claim 1, wherein:
a width of one of the plurality of zones in a direction along a traveling direction of the passageway is a width that allows only one person to pass through the passageway, and
in a case where a plurality of the foreign objects corresponding to a plurality of the persons is detected in the passageway, the determiner determines whether the plurality of persons has passed through the passageway, by assuming that replacement of an order of the plurality of persons along the traveling direction of the passageway does not occur until the plurality of persons passes through the passageway.

11. The information processing apparatus according to claim 1, wherein
the determiner sets a width of one, some or all of the plurality of zones in a direction along a traveling direction of the passageway to a width that varies depending on a position of the person in the image.

12. The information processing apparatus according to claim 11, wherein
the determiner sets the width of a zone of the plurality of zones to be narrower as the position of the person is closer to a center of the image, the zone being close to a center of the passageway.

13. The information processing apparatus according to claim 1, wherein
the passageway is a passageway in a gate at which face authentication of the person is performed.

14. An information processing method, comprising:
performing, by one or more information processing apparatuses, detection of a foreign object, in an image obtained by capturing a passageway from above, for each of a plurality of zones set to the passageway, the foreign object being an object not included in the image in a stationary state; and
determining, by the one or more information processing apparatuses, whether a person corresponding to the foreign object has passed through the passageway based on a change over time in a zone in which the foreign object is detected, among the plurality of zones.

15. A program that causes one or more information processing apparatuses to perform:
processing of performing detection of a foreign object, in an image obtained by capturing a passageway from above, for each of a plurality of zones set to the passageway, the foreign object being an object not included in the image in a stationary state; and
processing of determining whether a person corresponding to the foreign object has passed through the passageway based on a change over time in a zone in which the foreign object is detected, among the plurality of zones.
